(19) United States
(12) Patent Application Publication
(10) Pub. No.: US 2004/0156539 A1
(43) Pub. Date: Aug. 12, 2004

(54) Inspecting an array of electronic components

(75) Inventors: David Anders Jansson, Los Altos Hills, CA (US); Wing Hong Leung, Kwai Chung (HK); Xu Qiong Chen, Kwai Chung (HK)

Correspondence Address: OSTROLENK FABER GERB & SOFFEN, 1180 AVENUE OF THE AMERICAS, NEW YORK, NY, 100368403

(73) Assignee: ASM Assembly Automation Ltd

(21) Appl. No.: 10/361,953

(22) Filed: Feb. 10, 2003

(51) Int. Cl. G06K 9/00

(52) U.S. Cl. 382/145

(57) ABSTRACT

The invention provides an apparatus and method for inspecting an array of electronic components. The apparatus comprises a scanning device adapted to capture images of at least one surface of each of the respective components, whereby to inspect said surface. The scanning device may be a line scanning device.

### FIELD OF THE INVENTION

This invention relates to a method and apparatus for inspecting electronic components, such as semiconductor substrates with integrated circuits (“ICs”) attached thereon, and in particular, to an automated inspection apparatus using scanning techniques. Such electronic components include, without limitation, semiconductor dice and leadframe packages that are involved in the packaging of a semiconductor IC package.

### BACKGROUND AND PRIOR ART

In a typical packaging process of IC packages, such as Quad Flatpack No-lead (“QFN”) or Ball-Grid Array (“BGA”) packages, a plurality of encapsulated IC packages are usually formed on a single strip of substrate. These individual packages are then separated in a singulation process. Prior to or after singulation, the encapsulated packages on the substrates should be inspected to detect structural and other faults, such as lead coplanarity (for leaded packages) and defects in formation of a molded compound. Defects may affect the performance of the IC packages.

Such inspection may be performed by a human operator physically checking the packages for defects, but that is not ideal. To increase inspection speed and avoid errors attributable to manual inspection, optical means may be used for automated inspection of IC packages. An example is PCT publication no. WO 00/33027 for “An apparatus and method to transport, inspect and measure objects and surface details at high speeds.” It discloses an apparatus for the inspection of objects or leaded objects such as singulated integrated circuit packages comprising top view imaging sensors for top view inspection and for side inspection, a triangle-shaped track, the base of which supports the packages, with the apex of the triangle in an inverted pyramid position. Primarily, the apparatus described therein inspects singulated IC packages that are placed on an elongated track which is inclined for gravity feed and movement of the objects. High-speed rollers and stoppers are used to separate the IC packages from one another. There are also reflective surfaces below the traveling path of the IC packages to inspect the packages from different perspectives.

However, there are a number of problems with such an approach. Since the IC packages have already been singulated, they are more difficult to handle. With the ever-decreasing size of IC packages, the level of difficulty is increased. One instance of this is that an elaborate construction of gravity and high-speed rollers have to be used to separate each IC package. It would be advantageous to be able to inspect the IC packages while they are still part of their substrates, eg. while they are still on the unsingulated substrates. This method is more efficient and cost-effective, especially since IC packages are getting smaller all the time and it would be difficult to handle them individually once they are separated.

Further, a relatively complex combination of reflective surfaces, strobe lighting and application of pressure on the packages against a track is required to obtain accurate measurements of each package. It is also apparent that this prior art uses an area array camera, which takes an image of the whole surface of the package. The inspection resolution of an area array camera is limited by the camera resolution, and such resolution may not be sufficient when the width of the structure to be inspected gets larger. Utilizing a linear or line camera can offer high resolution and provide increased productivity. Additional benefits come from advances in both speed and resolution without the need to completely upgrade the base station.

### SUMMARY OF THE INVENTION

It is therefore an object of the present invention to seek to overcome some of the aforementioned disadvantages of the prior art by introducing an improved apparatus for inspecting electronic components, such as substrates with IC packages formed thereon. It would further be advantageous to develop a method and apparatus capable of inspecting IC packages while they are unsingulated and still part of their substrates during a packaging process.

According to a first aspect of the invention there is provided an apparatus for inspecting an array of electronic components, comprising a scanning device adapted to capture images of at least one surface of each of the respective components, whereby to inspect said surface.

According to a second aspect of the invention there is provided a method for inspecting an array of electronic components, comprising capturing images of at least one surface of each of the respective components, whereby to inspect said surface using a scanning device.

It will be convenient to hereinafter describe the invention in greater detail by reference to the accompanying drawings which illustrate one embodiment of the invention. The particularity of the drawings and the related description is not to be understood as superseding the generality of the broad identification of the invention as defined by the claims.

### BRIEF DESCRIPTION OF THE DRAWINGS

FIG. 1 shows a typical back-end Packaging Process Flow for micro-electronic components such as IC (Integrated Circuit) and LED (Light Emitting Diode) devices;

FIG. 2 shows a plan view of a wafer comprising a plurality of dice and a scanner to scan the wafer;

FIG. 3 shows a plan view of a simplified die sorting machine useable in the Die Sorting Process;

FIG. 4 shows a plan view of a simplified wafer mapping machine useable in the Wafer Mapping Process;

FIG. 5 shows a plan view of a simplified stub bumping machine usable in a Stub Bumping Process;

FIG. 6 shows a plan view of a substrate and a scanner for pre-bond scanning prior to a Die Bonding Process;

FIG. 7 shows a plan view of a simplified die bonder useable in the Die Bonding Process;

FIG. 8 shows a plan view of a substrate and a scanner where the substrate moves under the scanner for post-bond scanning;

FIG. 9 shows a plan view of a simplified wire bonder useable in a Wire Bonding Process;

FIG. 10 shows a plan view of a simplified molding or encapsulation machine useable in an Encapsulation Process;

FIG. 11 shows a plan view of a simplified ball placement machine useable in a Ball Placement Process;

FIG. 12 shows a plan view of a simplified marking machine useable in a Marking Process;

FIG. 13 shows a plan view of a simplified trim & form machine useable in a Trimming and Forming Process;

FIG. 14 shows a plan view of a simplified strip testing machine useable in a Strip Testing Process;

FIG. 15 is an isometric view of an inspection station of an apparatus according to the preferred embodiment of the invention;

FIG. 16 is a schematic illustration of multiple illumination sources usable with the preferred embodiment of the invention; and

FIG. 17 is a schematic diagram of the main components comprised in the apparatus for inspection.

### DETAILED DESCRIPTION OF THE PREFERRED EMBODIMENT OF THE INVENTION

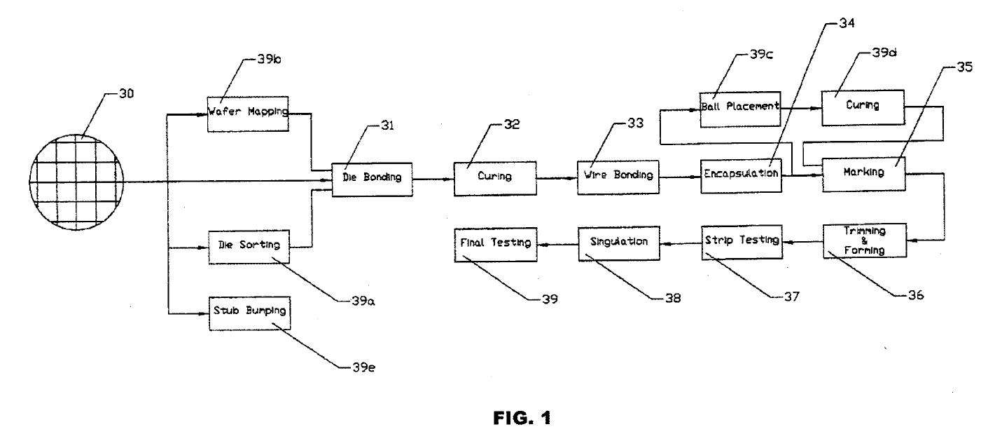

FIG. 1 shows a typical back-end Packaging Process Flow for micro-electronic components such as IC (Integrated Circuit) and LED (Light Emitting Diode) devices. Note that the process flow described is exemplary, and therefore some steps may be omitted or added, or combined or split, in other implementations. Actual implementation may also deviate from the flow depending on the property of the substrate, die and package type:

a. Semiconductor dice to be used in electronic packages are typically transported in the form of a wafer 30.

b. Prior to attaching a semiconductor die to a substrate in a Die Bonding Process 31, dice may be electrically, optically and visually tested for classification and grade sorting and transferred to different containers in accordance with their grade classification in a Die Sorting Process 39a. Then, containers with the same grade of die will be input to the die bonder for the Die Bonding Process 31. The Die Sorting Process 39a will ensure that only devices with similar characteristics will be used in the same electronics assembly.

c. Similar to the Die Sorting Process 39a, the dice on the wafer 30 may be electrically, optically and visually tested for classification and grade sorting but instead of being transferred to different containers for different grades, the grading information is saved in a computer file in a Wafer Mapping Process 39b. Then the wafer 30 and computer file containing the grading information will be input to a die bonder in the Die Bonding Process 31. The die bonder will pick and bond the desired grade of die according to need.

d. For some package types such as flip chips, there may be a Stub Bumping Process 39e where bumps are formed on the Input/Output Pads of dice on the wafer by a bumping machine to form electrical contacts.

e. In the Die Bonding Process 31, a die is transferred from the wafer 30 and bonded by adhesive material to a substrate (eg. a lead frame).

f. After the Die Bonding Process 31, the adhesive is cured by an oven in a Curing Process 32.

g. Wires are then bonded between Input/Output Pads on the die and contacts (eg. leads) on a substrate to form electrical connections in a Wire Bonding Process 33.

h. The substrate is encapsulated by molding material to form a protective casing in an Encapsulation Process 34.

i. For some package types such as Ball-Grid-Arrays (“BGA”), after the Encapsulation Process 34, solder balls are placed with adhesive onto the devices on the substrate to form electrical contacts in a Ball Placement Process 39c and then cured by an oven in a Curing Process 39d.

j. A mark (eg. Part Number and Logo) may then be printed or laser marked on the surface of the electronic devices for identification in a Marking Process 35.

k. For certain package types, the substrate is then trimmed and formed to isolate the lead tips from the substrate and to form it into a certain shape, such as a gull wing shape, in a Trimming and Forming Process 36.

l. The devices on the substrate are electrically tested, functionally tested and optically tested (for LEDs) and visually inspected in a Strip Testing Process 37.

m. Electronic devices on the substrate are then divided in a Singulation Process 38.

n. Electronic devices may be tested individually after singulation in a Final Testing Process 39.

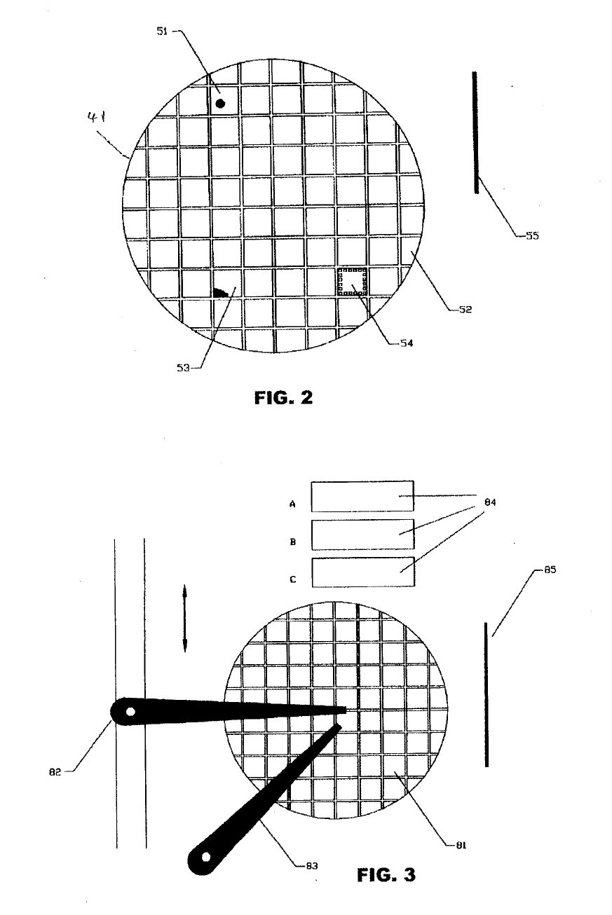

FIG. 2 shows a plan view of a wafer 41 comprising a plurality of electronic components in the form of semiconductor dice and a line scanning device in the form of a line scanning station or line scanner 55 according to an embodiment of the invention (denoted by a single line) to scan the wafer 41. The top surface of the wafer 41 is scanned. FIG. 2 illustrates the wafer having an “inked die” 51, “incomplete die” 52, “chipped die” 53 and “good die” 54. The wafer 41 is scanned by generating relative motion between the wafer 41 and the line scanner 55. The motion can be one-dimensional if the field-of-view of scanning is long enough to cover the wafer, or two-dimensional (as in FIG. 2) if it is not enough to cover the whole wafer. Optionally, position signals from a position encoder is fed back to a motion controller to control the relative motion between the wafer 41 and the line scanner 55. An optical image of the wafer is formed at the line scanner 55 and transmitted to a frame-grabbing device to form a computer image for automatic alignment, visual inspection, classification and measurement. Such scanning may be used to conduct automatic position and orientation alignment, visual inspection (such as contamination detection), classification (such as good die, inked die, chipped die) and measurement of dice (such as die size) in the wafer

FIG. 3 shows a plan view of a simplified die sorting machine useable in the Die Sorting Process 39a. A die sorting machine is used to characterize the electrical property and/or optical property and/or visual quality of dice such as LED for classification and grading. It may consist of a wafer sub-system 81, a pick arm assembly 82, an electrical and optical test probe arm 83, containers for graded die 84 and a line scanner 85. The wafer sub-system 81 is scanned by the line scanner 85 for automatic visual inspection. Each individual die is then electrically and optically tested by the probe arm 83. Each die is classified and graded based on its electrical and optical characteristics and visual quality. Then it is picked up by the pick arm assembly 82 and put into one of several receiving containers 84 (eg. ring with Mylar paper) for different classes or grades.

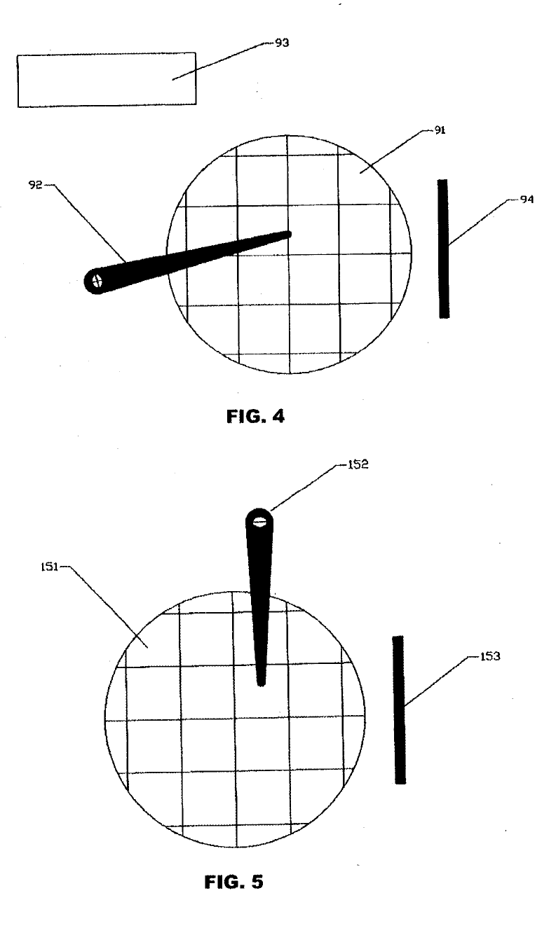

FIG. 4 shows a plan view of a simplified wafer mapping machine useable in the Wafer Mapping Process 39b. Its functionality is similar to the die sorting machine except that the die is not transferred to any container. Instead, after inspecting characteristics of each electrical component for classification and grading, the inspected characteristic as well as an identifying parameter of a die (for example, its position in the array) are stored in a computer data file. This data will be used by other downstream packaging processes for later identification of the electronic component. The wafer mapping machine may consist of a wafer sub-system 91, an electrical and optical test probe arm 92, file storage device 93 and line scanner 94. The wafer sub-system 91 is scanned by the line scanner 94 for automatic visual inspection. Each individual die is then electrically and optically tested by the probe arm 92. Each die is classified and graded based on its electrical and optical characteristics and visual quality. Then the information is saved in the file storage device 93.

FIG. 5 shows a plan view of a simplified stub bumping machine usable in a Stub Bumping Process 39e. Its function is to form stub bumps on Input/Output pads of dice in a wafer as electrical contacts, in particular for flip chip and other similar package types. It may consist of a wafer sub-system 151, a stub bumping sub-system 152 and a line scanner 153. Stub bumps are formed on each die at the wafer sub-system 151 by the stub bumping sub-system 152. After bumping, the wafer is scanned by the line scanner 153 and images grabbed by the line scanner 153 are analyzed to detect any visual defect on the die and defects generated by the bumping process.

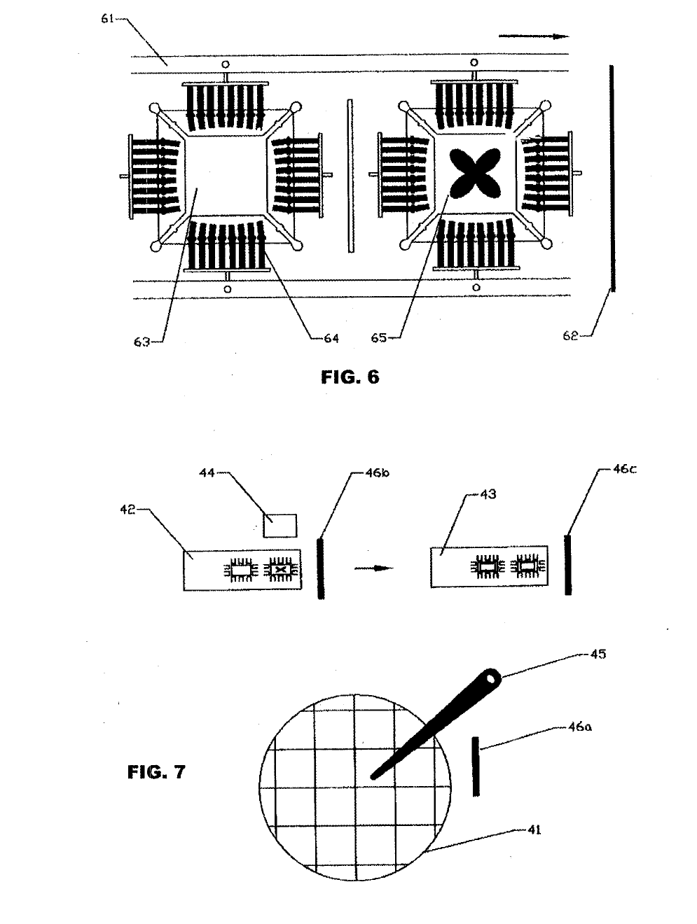

FIG. 6 shows a plan view of a substrate 61 and a line scanner 62 for pre-bond scanning prior to the Die Bonding Process 31. Pre-bond scanning may be used to conduct automatic visual inspection (such as contamination detection, lead bending detection), classification (such as crossed unit, poor plated unit, good unit) and measurement (such as size of die pad, lead width) of incoming substrates (such as lead frames for die bonding) and to conduct automatic visual inspection (such as shape) and measurement (such as area and length) of epoxy dispensed on the substrate. The substrate 61 moves under the scanner 62 for inspection. On each device, there is a die pad 63, leads 64 and dispensed epoxy 65 for visual inspection, classification and measurement.

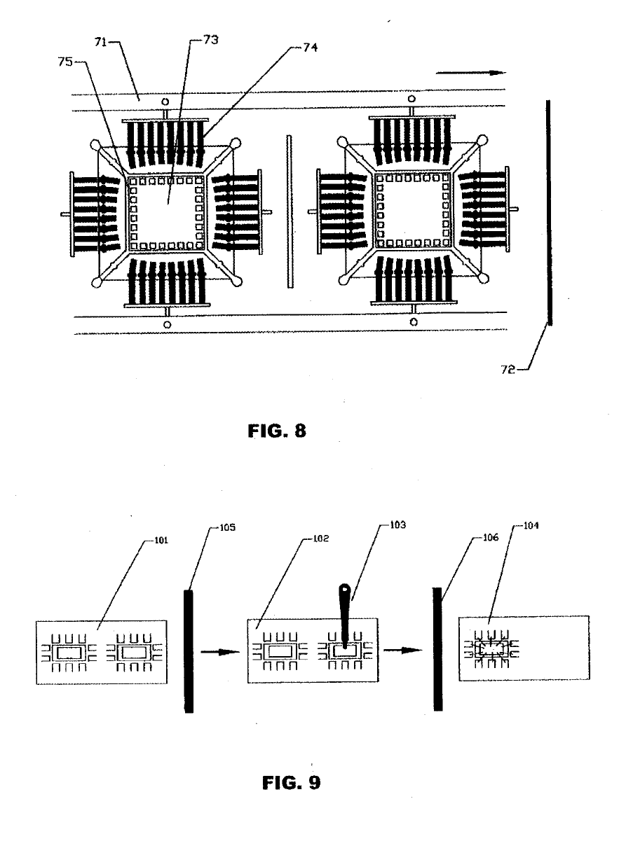

FIG. 7 shows a plan view of a simplified die bonder useable in the Die Bonding Process 31. The machine picks up dice (usually from a wafer) and places the dice on substrates such as lead frames for bonding (attachment). It may consist of a wafer sub-system 41, a pre-bond sub-system 42, a bonding sub-system 43, an epoxy dispensing or stamping sub-system 44, a bond arm 45 and three line scanners 46a, 46b, 46c. Epoxy is dispensed or stamped by the epoxy dispensing or stamping sub-system 44 onto the substrate at the pre-bond sub-system 42. The substrate is then put under the line scanner 46b for pre-bond scanning. Thereafter, the substrate is transferred to the bonding sub-system 43 for bonding. Good dice are picked up by the bond arm 45 from the wafer sub-system 41 and placed onto a good device at the bonding sub-system 43 for bonding. After bonding, the substrate is transferred under the line scanner 46c for post-bond scanning. The wafer is scanned by the line scanner 46a. Images grabbed by line scanners 46a, 46b, 46c are analyzed by a vision system for visual alignment, inspection, classification and measurement.

FIG. 8 shows a plan view of a substrate 71 and a scanner 72 where the substrate 71 moves under the scanner 72 for post-bond scanning. The purpose of post-bond scanning is to conduct automatic visual inspection (such as contamination detection, lead bending detection, bonding quality checking), classification (such as identifying a poorly bonded unit, contaminated unit or good unit) and measurement (such as measuring position offset of bonding) of die bonded substrates. On the substrate 71, there is the bonded die 73, leads 74 and die pad 75 for visual inspection, classification and measurement. An optical image of the substrate 71 is formed at the line scanner 72 and transmitted to a frame-grabbing device to form a computer image for processing.

FIG. 9 shows a plan view of a simplified wire bonder useable in the Wire Bonding Process 33. It is used to bond wires between Input/Output Pads on dice that are already attached to a substrate and contacts (such as leads) on the substrate to form electrical connections. Prior to bonding, the visual quality of the die (eg. defect on die), die attaching process (eg. position offset of die relative to die pad) and substrate (eg. bending of lead) may be “pre-bond” inspected. After the wire bonding process, the quality of the bonded wire may be “post-bond” inspected (eg. position of wire bonding, shape of bonding) in similar processes to the ones described above in relation to die bonding. The system may consist of an on-loader 101, a work-holder 102, a bonding assembly 103, an off-loader 104, pre-bond line scanner 105 and post-bond line scanner 106. A substrate at the on-loader 101 is put under the pre-bond line scanner 105 towards the work holder 102. An image grabbed by the pre-bond line scanner 105 is analyzed by a vision system for visual quality checking of the die, die attaching process and substrate. If the substrate is good, wire bonding will be performed on the substrate at the work-holder 102 by the bonding assembly 103. After wire bonding, the substrate at the work-holder 102 will be put under the post-bond line scanner 106 towards the off-loader 104. The image grabbed by post-bond line scanner 106 will be analyzed for visual quality checking of wire bonding quality.

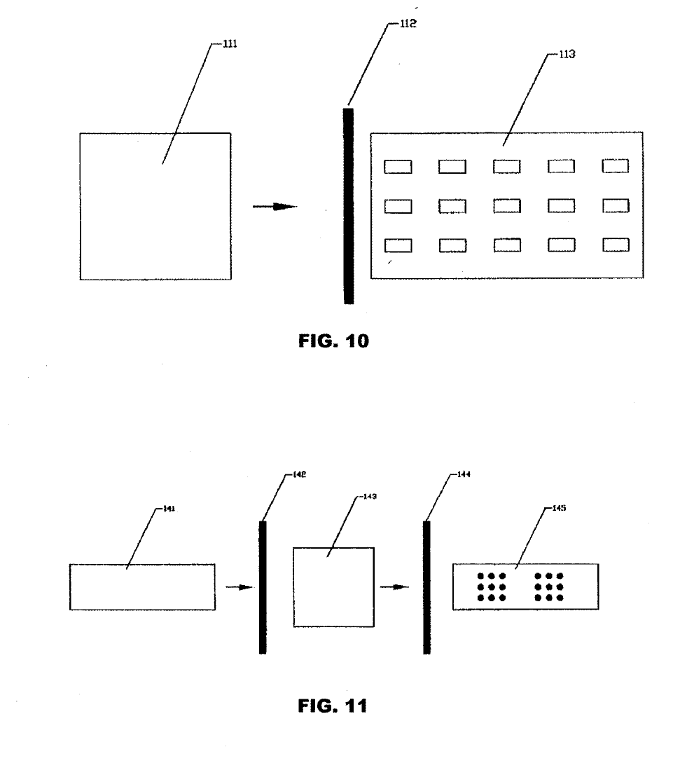

FIG. 10 shows a plan view of a simplified molding or encapsulation machine useable in the Encapsulation Process 34. The encapsulation machine is used to encapsulate the substrate with molding material to provide mechanical protection. It may consist of a molding sub-system 111, a line scanner 112 and an off-loader 113. After being molded in the molding sub-system 111, the substrate is transferred under the line scanner 112 to the off-loader 113. An image grabbed by the line scanner 112 is then analyzed to detect any molding process defect.

FIG. 11 shows a plan view of a simplified ball placement machine useable in the Ball Placement Process 39c. The machine is used to place balls with adhesive onto the devices to form electrical contacts for Ball-Grid-Array (“BGA”) or similar package types. It may consist of an on-loader 141, pre-placement line scanner 142, ball placement sub-system 143, post-placement line scanner 144 and an off-loader 145. A substrate at the on-loader 141 is transferred under the pre-placement line scanner 142 to the ball placement sub-system 143. Images grabbed by the pre-placement line scanner 142 may then be analyzed to detect any visual substrate defect, and if there is a defect, that device will be skipped. Balls and adhesive are attached to the substrate in the ball placement sub-system 143. After ball placement, the substrate is transferred under the post-placement line scanner 144 to the off-loader 145. Images grabbed by the post-placement line scanner 144 may be analyzed to detect any ball placement defect.

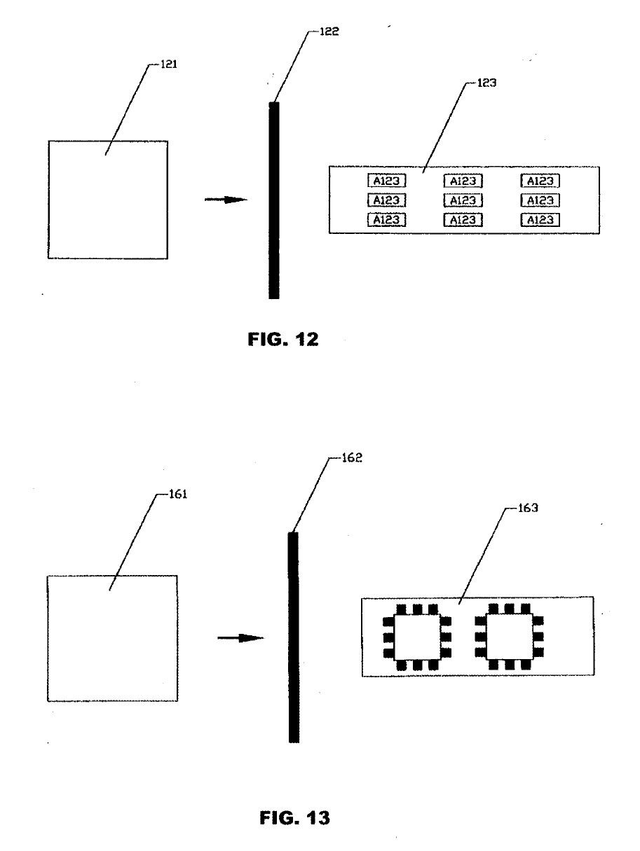

FIG. 12 shows a plan view of a simplified marking machine useable in the Marking Process 35. The machine puts an identification mark, such as Part Number of a device and/or logo of a company on the surface of the device. It may consist of a marking sub-system 121, a line scanner 122 and an off-loader 123. After marking in the marking sub-system 121, the substrate is put under the line scanner 122 towards the off-loader 123. An image grabbed by the line scanner 122 is then analyzed to inspect marking quality and detect any marking process defect.

FIG. 13 shows a plan view of a simplified trim & form machine useable in the Trimming and Forming Process 36. The machine is used to trim and form a substrate for certain package types to isolate lead tips from the substrate and form it to certain shapes, such as a gull wing shape. It may consist of a trim & form sub-system 161, a line scanner 162 and an off-loader 163. After being trimmed & formed in the trim & form sub-system 161, the substrate is put under the line scanner 162 towards the off-loader 163. The image grabbed by the line scanner 162 is then analyzed to detect any defect resulting from the Trimming and Forming Process 36.

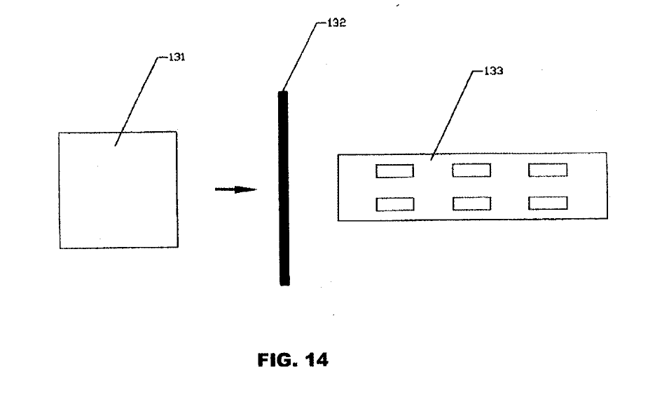

FIG. 14 shows a plan view of a simplified strip testing machine useable in the Strip Testing Process 37. The machine functionality is to perform electrical, functional, optical (for LED) and automatic visual inspection of the devices on the substrate. It consists of an electrical, functional and optical test sub-system 131, a line scanner 132 and an off-loader 133. After testing in the electrical, functional and optical test sub-system 131, the substrate is put under the line scanner 132 towards the off-loader 133. Images grabbed by the line scanner 132 are then analyzed to detect any visual defect.

The use of an inspection apparatus in relation to the Singulation Process 38 and Final Testing Process 39 are similar to the structures outlined above and will not be further detailed.

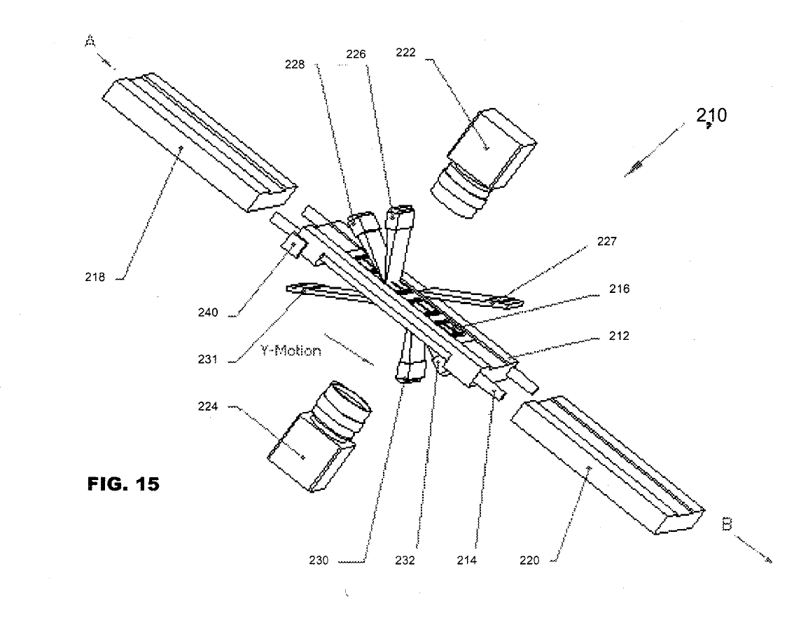

FIG. 15 is an isometric view of an inspection station 210 of an apparatus according to a preferred embodiment of the invention to inspect an array of electronic components. In the embodiment described, the apparatus is being used to inspect an array of electronic components in the form of a substrate that has undergone encapsulation in the Encapsulation Process 34. Equally, the substrate may comprise an array of semiconductor dice in the form of a wafer. Preferably, conveying means should generate relative movement between the array of electronic components and the line scanning device. Typically, the array of electronic components or the line scanning device, or both, may be moved. In the embodiment described, only the array of electronic components is moved by the conveying means.

An inspection station 210 of the apparatus where the substrate is inspected includes a conveying device such as a shuttle unit 212 that is mounted on guide rails 214 comprising air bearings to enable Y-axis motion of the shuttle unit 212. A molded but unsingulated substrate 216 with molded IC packages thereon is placed on the shuttle unit 212, and is transported from an on-loader 218 to an off-loader 220, as the substrate 216 is conveyed in direction A to the inspection station 210 and in direction B away from the inspection station 210. An advantage of having an air bearing shuttle unit 212 as compared to the prior art is that this ensures a smooth constant velocity control and vibration isolation, as compared to conventional types of conveyors or using gravity. Air bearings offer consistent pitch, yaw and roll characteristics as well as bearing stiffness. Although in this embodiment, movement along one axis is sufficient, the apparatus can be adapted for movement along another axis perpendicular to the said axis, for particular applications such as that described in FIG. 2.

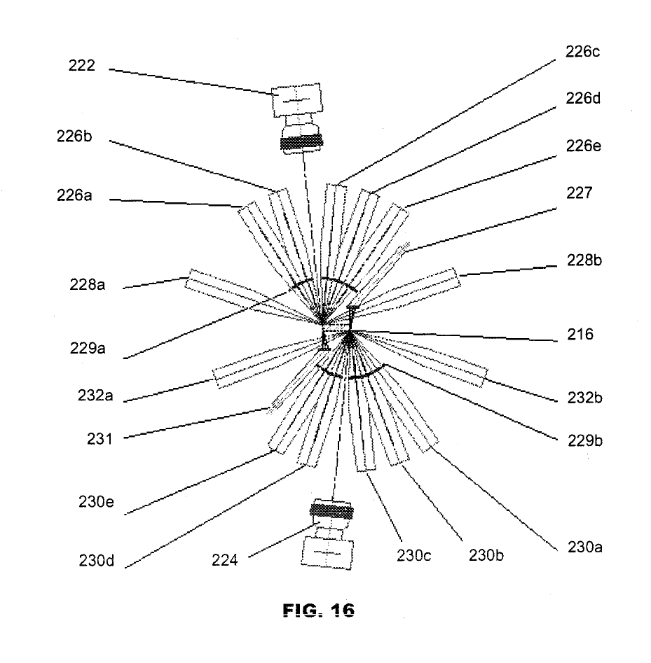

A scanning device, which may be in the form of a high-resolution top linear CCD camera 222 is positioned over the substrate 216 and a high-resolution bottom linear CCD camera 224 is positioned below the substrate 216, to capture images of the top and bottom surfaces of the substrate 216 respectively. The apparatus uses line-scan technology. Illumination means in the form of LED lights or other forms of lighting are used to project light onto the surface of the substrate. Top LED lights 226, 228 project bright field-dark field light beams onto the top surface of the substrate 216 whereas bottom LED lights 230, 232 (see FIG. 16) project bright field-dark field light beams onto the bottom surface of the substrate 216. The surfaces of the substrate 216 may also be illuminated from behind by top and bottom silhouette lighting or backlighting 227, 231 in conjunction with the bright field-dark field light beams to enhance contrast. This is desirable where there is an offset in positions of the set of lighting at the top and the set of lighting at the bottom of the apparatus. Alternatively, backlighting may be provided by illumination bars 226a-e, 230a-e (see FIG. 16) if there is no offset between the positions of the sets of top and bottom lighting. Technically, bright field illumination coupled with dark field illumination optimizes feature contrast while reducing surface texture noise. Backlighting may further be added to provide a silhouette of the object and give a high-contrast image of the object boundary for accurate dimension measurement and outline (boundary) inspection.

The shuttle unit 212 includes a position encoder, preferably a linear encoder 240 to provide positional information that helps to control motion of the substrate 216. The position of the shuttle unit 212 may thus be monitored by the linear encoder 240. The linear encoder 240 may also serve to synchronize image-capturing activities of the cameras 222, 224. The inspection station 210 provides continuous top and bottom inspection of the encapsulated substrate 216 as the substrate 216 is conveyed in a controlled manner by the shuttle unit 212 from the on-loader 218 to the off-loader 220.

An image processing device processes images captured by the scanning device to receive an inspected characteristic of each electronic component (eg. particular defects, type of component, alignment and dimensions, etc) together with an identifying parameter of the component (eg. its position in the array). Such information is stored for later identification of the component. Therefore, if a defective component is located, its position in the array will be recognized and it may be skipped during further processing of the array so as to maximize processing resources.

FIG. 16 is a schematic illustration of multiple illumination sources usable with the preferred embodiment of the invention. The illumination sources may include a number of serial illumination bars 226a-e, 228a-b, 230a-e, 232a-b. They can provide even illumination with different combinations, such as bright field, dark field and a combination thereof with different functions achievable from the different effects. For example, bright field illumination offers a bright image for shiny surfaces such as leadframes and gray images for rough surfaces (such as dirt-filled surfaces), whereas dark field illumination offers a dark image for shiny surfaces and gray images for rough surfaces. Depending on the surface, bright field or dark field illumination is selected to give optimal contrast of features in the image. Illumination bars 226a-e may be used for bright field illumination for the upper surface of the substrate 216. Illumination bars 230a-e may be used for bright field illumination for the bottom surface of the substrate 216. Illumination bars 228a-b may be used for dark field illumination of the upper surface of the substrate 216, whereas illumination bars 232a-b may be used for dark field illumination of the bottom surface of the substrate 216. The illumination from illumination bars 226a-e, 228a-b, 230a-e and 232a-b may be focused onto the surfaces of the substrate 216 as a strip of light using a cylindrical lens focusing system or light guide/pipe system, or other similar systems.

Two lighting guides 227, 231 provide even backlighting for the bottom and upper surfaces of the substrate 216 respectively to produce silhouette images of the substrate 216 as discussed above. Two special lighting diffuser devices 229a, 229b may diffuse one or more light beams into a non-symmetrical pattern, such as an elliptical pattern. For this application, the diffusers 229a, 229b may diffuse the lighting from the illumination bars 226a-e, 230a-e in one direction to even out the lighting, but not in an opposite direction. Otherwise, it would reduce the lighting efficiency vastly. A suitable lighting diffuser usable with the invention is an LSD 40°×0.2° diffuser from Physical Optics Corporation.

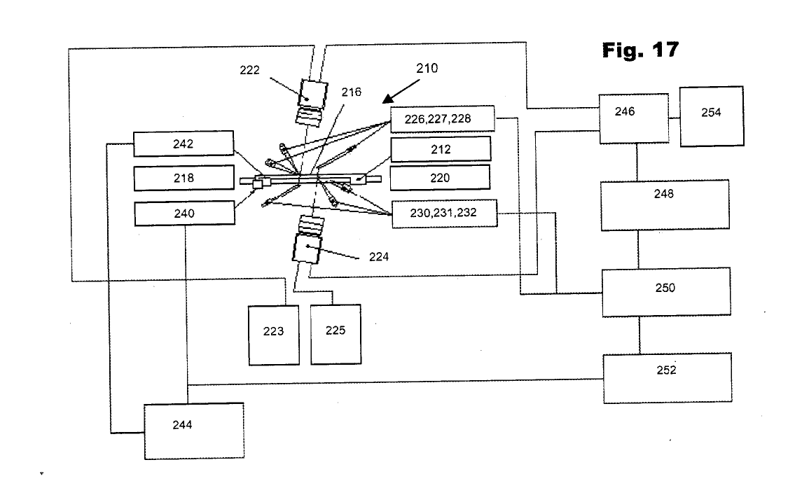

FIG. 17 is a schematic diagram of the main components comprised in the apparatus for inspection. A substrate 216 is transferred to the on-loader 218 of the inspection station 210. The on-loader 218 loads the substrate 216 onto the shuttle unit 212. The top LED lights 226, 228 and bottom LED lights 230, 232 illuminate narrow strips of the top and bottom surfaces of the substrate 216 respectively. Top backlighting 227 and bottom backlighting 231 create silhouettes of the respective surfaces of the substrate 216. The top and bottom cameras 222, 224, powered by camera power supplies 223, 225 capture images of the lighted strips of the top and bottom surfaces of the substrate 216, a strip at a time. The inspection region is therefore designed to be uniformly illuminated with a controlled lighting structure focused onto a light strip, which is composed of one of or a combination of lighting effects selected from high angle light 226a-e, 230a-e (bright field illumination), low angle light 228a-b, 232a-b (dark field illumiation) and silhouette lighting or backlighting 227, 231.

The shuttle unit 212 is moved incrementally by a linear motor 242 with positional reference provided by the linear encoder 240. Optionally, the cameras 222, 224 and lighting may be moved incrementally, either alone or together with corresponding movement of the shuttle unit 212, as long as there is essentially relative movement between the substrate and the cameras 222, 224 and lighting. Data from the linear encoder 240 is typically in RS-422 format and is converted by a signal conversion board 252 to TTL format, although other formats are also usable. The linear motor 242 may be controlled by a motion controller 244, such as a HiPEC (“High Performance External Virtual Memory Caching”) motion controller.

The top and bottom cameras 222, 224 have to be synchronized, and this may be achieved by a camera synchronization board module 246, that is powered by a power supply 254. A frame grabber 248, such as Matrox's Meteor 2 Dig, captures an image for processing by way of a vision system (not shown) connected to the frame grabber 248. A light control board 250 controls the illumination of the LED lights 226-228, 230-232.

A description of a typical scanning process using the line-scanning technique embodied in the preferred embodiment of the invention is now outlined. The inspection system 210 receives a signal from a host computer (not shown) that starts an inspection event. This signal from the host computer signals the HiPEC motion controller 244 to commence motion when a substrate 216 is loaded onto the shuttle unit 212. Motion begins. The encoder signals are counted by the signal conversion board until a number of “X” pulses (predetermined in the system) are counted. At a certain position, the frame grabber 248 and the lighting control board 250 are activated. The frame grabber 248 signals the first camera 222 and the second camera 224 to capture images as well as the lighting control board 250 to illuminate a continuous or a strobe light for capture. There may be software delays incorporated to synchronize frame grabbing and lighting. For every sampling period, say, every 20 μm, each camera may grab several strips of images with different lighting combinations for each strip. Thus, each camera 222, 224 captures multiple images of a selected portion of the array of electronic components, whereby each image is captured with a different lighting effect. For example, strip 1 with bright field lighting, strip 2 with backlighting, followed by strip 3 and so on. As a result, in a single scanning pass, several images of the substrate can be obtained with different lighting effects. As there exists positional offset between the images, though small, a suitable algorithm may correct the images to take into account such offset.

The number of images taken is programmable. This ensures that multiple images (both top view images and bottom view images) are captured for every 20 μm of motion. A different lighting effect can be generated for each image, thus achieving multiple images with different lighting effects to inspect various features. Preferably, the frame grabber 248 signals both the first camera 222 and the second camera 224 to capture images at the same time, although the cameras 222, 224 may be programmed to capture images alternately. In addition, in the described embodiment, the viewing position of the first camera 222 is preferably vertically-offset from the viewing position of the second camera 224, such that the viewing positions of the two cameras are spaced apart along the top and bottom surfaces, so that the lighting effects from the top and bottom surfaces do not interfere with each other. Further, after a complete scan of the surface of the substrate 216 is done in a single pass, multiple images of strips of light taken at various positions using particular lighting effects can be compiled and assembled to form a single representation comprising the whole surface area of the substrate 216 during processing.

It would be appreciated that although only one camera is required to inspect a surface of the substrate 216, the simultaneous top and bottom inspection of substrates with two cameras 222, 224 increases machine throughput and reduces machine handling. Not only is there inspection of molded surfaces encapsulating each IC package, there is sufficient depth of focus using this apparatus and method to inspect material on the substrate 216 itself, such as flash on the leads of leadframes. Alternatively, the frame grabber 248 may signal both the first camera 222 and the second camera 224 to capture images at the same time. However, in the described embodiment, the first camera 222 is preferably vertically-offset from the position of the second camera 224 so that the lighting effects from the top and bottom surfaces do not interfere with each other.

Furthermore, the flexible structured light achieved by bright-field, dark-field and backlight illumination can provide faster specific feature defect detection and alignment, as well as measurement, by means of adjusting illumination angles and intensities. The shuttle unit 212 comprising an air bearing transport unit provides the most stable mechanism for substrate inspection.

The invention described herein is susceptible to variations, modifications and/or additions other than those specifically described and it is to be understood that the invention includes all such variations, modifications and/or additions which fall within the spirit and scope of the above description.

1. An apparatus for inspecting an array of electronic components, comprising a scanning device adapted to capture images of at least one surface of each of the respective components, whereby to inspect said surface.

2. An apparatus according to claim 1, the scanning device being a line scanning device.

3. An apparatus according to claim 1, including an image processing device to receive an inspected characteristic of each component together with an identifying parameter of the component and to store it for later identification of the component.

4. An apparatus according to claim 1, including conveying means to generate relative movement between the line scanning device and the array of electronic components.

5. An apparatus according to claim 4, wherein the conveying means is a conveying device adapted to convey the array of electronic components along an axis through an area where the line scanning device is positioned in order to capture images of the electronic components.

6. An apparatus according to claim 5, wherein the conveying device is adapted to additionally convey the array of electronic components along another axis perpendicular to said axis.

7. An apparatus according to claim 5, wherein the conveying device is mounted on air bearings onto a guide for movement along said axis.

8. An apparatus according to claim 4, including a position encoder coupled to the conveying means adapted to provide positional information to a motion controller so as to control the relative positions of the line scanning device and the array of electronic components.

9. An apparatus according to claim 4, including a position encoder coupled to the conveying means adapted to synchronize image-capturing activities of the line scanning device.

10. An apparatus according to claim 2, including illumination means that is controllable whereby lighting from the illumination means may be focused as a strip of light onto the surface of the array of electronic components.

11. An apparatus according to claim 10, including a system selected from a cylindrical lens system and a light guide system to focus the illumination means into the strip of light.

12. An apparatus according to claim 10, including a lighting diffuser device to diffuse the lighting into a non-symmetrical pattern.

13. An apparatus according to claim 10, wherein the illumination means includes a plurality of illumination sources arranged to be capable of projecting different lighting effects onto the surface of the electronic components.

14. An apparatus according to claim 13, wherein the lighting effects comprise lighting effects selected from the group consisting of bright field illumination, dark field illumination and backlighting and silhouette lighting.

15. An apparatus according to claim 13, wherein the scanning device is adapted to capture multiple images of a selected portion of the array of electronic components that is inspected.

16. An apparatus according to claim 15, wherein the scanning device and illumination means are adapted such as to capture each image of the multiple images with a different lighting effect that is projectable onto the array of electronic components.

17. An apparatus according to claim 1, wherein the images are captured in a single scanning pass of the object.

18. An apparatus according to claim 1, wherein the scanning device comprises two cameras, each located adjacent to, and having a viewing position on, opposite surfaces of the array of electronic components to be inspected, whereby both surfaces of the electronic components may be inspected simultaneously.

19. An apparatus according to claim 18, wherein the viewing positions of the two cameras are spaced apart along the surfaces of the array.

20. An apparatus according to claim 1, wherein the apparatus is adapted to be coupled to or integrated into a machine that performs one or more functions in a semiconductor assembly process, whereby to automatically inspect the array of electronic components before and/or after processing by the machine.

21. An apparatus according to claim 20, wherein the array of electronic components are inspected for a purpose selected from the group consisting of identifying defects, determining alignment, classification of type, measurement of dimensions, identifying a component, checking quality of components and quality of process.

22. An apparatus according to claim 20, wherein the apparatus is adapted to be coupled to or integrated with a machine selected from the group consisting of a wafer mapping machine, a die bonder machine, a die sorting machine, a wire bonding machine, a marking machine, an encapsulation machine, a trim and form machine, a ball-placement machine, a stub-bumping machine and a strip-testing machine.

23. A method for inspecting an array of electronic components, comprising capturing images of at least one surface of each of the respective components, whereby to inspect said surface using a scanning device.

24. A method according to claim 23, comprising inspecting said at least one surface using a line scanning device.

25. A method according to claim 23, including receiving an inspected characteristic of each component together with an identifying parameter of the component and storing it for later identification of the component.

26. A method according to claim 23, including generating relative movement between the line scanning device and the array of electronic components.

27. A method according to claim 26, comprising conveying the array of electronic components along an axis through an area where the line scanning device is positioned in order to capture images of the electronic components.

28. A method according to claim 27, including conveying the array of electronic components along another axis perpendicular to said axis.

29. A method according to claim 26, including obtaining positional information of a conveying means using a position encoder coupled to the conveying means, and providing the information to a motion controller so as to control the relative positions of the line scanning device and the array of electronic components.

30. A method according to claim 29, including synchronizing image-capturing activities of the line scanning device using the position encoder.

31. A method according to claim 24, including providing illumination means that is controllable.

32. A method according to claim 31, including focusing light from the illumination means as a strip of light onto the surface of the array of electronic components.

33. A method according to claim 31, including providing a lighting diffuser device to diffuse the lighting into a non-symmetrical pattern.

34. A method according to claim 31, wherein providing the illumination means includes providing a plurality of illumination sources projecting different lighting effects onto the surface of the electronic components.

35. A method according to claim 34, wherein providing the lighting effects comprises selecting same from the group consisting of bright field illumination, dark field illumination and backlighting, and silhouette lighting.

36. A method according to claim 34, including capturing multiple images of a selected portion of the array of electronic components that is inspected.

37. A method according to claim 36, wherein each image of the multiple images is captured with a different lighting effect that is projected onto the array of electronic components.

38. A method according to claim 24, wherein the multiple images are captured in a single scanning pass of the object.

39. A method according to claim 24, wherein the scanning device comprises two cameras, each located adjacent to, and having a viewing position on, opposite surfaces of the array of electronic components to be inspected, whereby both surfaces of the electronic components may be inspected simultaneously.

40. A method according to claim 39, wherein the viewing positions of the two cameras are spaced apart along the surfaces of the array.

41. A method according to claim 24, wherein the array of electronic components are automatically inspected before and/or after processing by a machine that performs one or more functions in a semiconductor assembly process.

42. A method according to claim 41, wherein the array of electronic components are inspected for a purpose selected from the group consisting of identifying defects, determining alignment, classification of type, measurement of dimensions, identifying a component, checking quality of components and quality of process.

43. A method according to claim 41, wherein the machine is selected from the group consisting of a wafer mapping machine, a die bonder machine, a die sorting machine, a wire bonding machine, a marking machine, an encapsulation machine, a trim and form machine, a ball-placement machine, a stub-bumping machine and a strip-testing machine.
